(19) United States
(12) Patent Application Publication
(10) Pub. No.: US 2001/0010858 A1
(43) Pub. Date: Aug. 2, 2001

(54) Concrete product having a retroreflective surface and its production process

(76) Inventors: Tomoaki Uchiya, Tokyo (JP); Satoshi Nakajima, Tokyo (JP); Touta Adachi, Tokyo (JP)

Correspondence Address: Attention: Rudolph P. Hofmann, Jr., Office of Intellectual Property Counsel, 3M Innovative Properties Company, PO Box 33427, St. Paul, MN, 55133-3427, US

(21) Appl. No.: 09/730,123

(22) Filed: Dec. 5, 2000

(30) Foreign Application Priority Data
Dec. 7, 1999 (JP) 11-347894

(51) Int. Cl. B32B 5/16; B29D 11/00; B28B 1/16; B32B 31/18

(52) U.S. Cl. 428/147; 428/149; 264/1.9; 264/338; 264/139; 264/256

(57) ABSTRACT

This disclosure provides a concrete product having a retroreflective surface with uniform and sharp edge which is produced easily with shortened time without using a special equipment or process as well as chemicals which need special attention in handling. The disclosure also establishes a method to obtain the substrate consisting of a concrete-based material and a retroreflective element dispersed and embedded at least in a surface portion of said substrate, at least a part of which element is exposed from a surface of said substrate and the said retroreflective element being exposed from the substrate surface as a result of partially retarded hardening of the said concrete-based material and removal of the thus produced, unhardened concrete material.

### BACKGROUND

This disclosure relates to the concrete products, and specifically, the concrete products having a retroreflective surface. Also, this disclosure relates to the production process of the concrete products having a retroreflective surface.

Recently, concrete products having retroreflective surface are used in many fields because of the good visibility and recognizability, design effect, decorative effect and attention-drawing effect which are the result of the characteristic reflective property. The typical examples of these concrete products are such as interlocking blocks which are used in pedestrian walks, shopping malls and amusement parks, guiding blocks installed in parking lots, zebra patterns on the road (crossing) and other traffic signs.

Manufacturing of concrete product having a retroreflective surface is performed in various methods. For example, in Patent Publication of Toku Kai Hei 7-96766, interlocking block is disclosed which is characterized by being the interlocking block wherein the surface layer concrete is partially or totally applied on the base layer concrete and a portion or total aggregate for said surface layer concrete is substituted by the beads of particle diameters of between 0.08 and 10 mm which have retroreflective property and coated with light transmissive synthetic resin on the surface. The concrete dispersed with the beads which give retroreflective surface is poured into a production mold, the poured concrete into the mold is applied with vibration together with the mold in order to expose the glass beads after the curing of the concrete, the concrete is cured and hardened and this interlocking block is produced. However, with this production process, special equipment and excess time are needed to vibrate mold and there is a difficult problem such as exposing the glass beads uniformly on the surface of concrete product.

Also, in patent publications such as Toku Kai Shou 61-239940 and Toku Kai Hei 3-192202, production process of the concrete product such as signs is disclosed which is characterized by that the glass beads are fixed into a predetermined site of the production mold in advance by using adhesive and tacky agent then the concrete is cured after pouring the raw concrete into the mold. With this production process, exposing glass beads evenly on the surface of the concrete product becomes easy, however, a complex process to fix glass beads to the mold in advance is necessary and the production time and cost would increase.

Furthermore, a method is known in which after the concrete containing the dispersed glass beads is poured into the production mold and cured, the surface of the cured concrete is washed by using acid and the embedded glass beads in the concrete are exposed. However, in this production method, usage of acid is inevitable, a careful handling is necessary, it takes a long time for washing and the treatment of the waste liquid becomes an important issue. Furthermore, there is a drawback in this retroreflective surface obtained by this method such as that a sharp edge is not easily obtained.

### SUMMARY

This disclosure describes a concrete product having a retroreflective surface by solving above described problems of conventional technology: the product can be easily produced with the shortened time to have a uniform surface having a sharp edge, without using a special equipment and process at the time of the production as well as chemicals requiring handling with special care. This disclosure also describes a production process of the concrete product.

According to the present disclosure, the above object can be accomplished by a concrete product having a retroreflective surface, characterized by comprising a substrate having of a concrete-based material and a retroreflective element dispersed and embedded at least in a surface portion of said substrate, at least a part of which element is exposed from a surface of said substrate, said retroreflective element being exposed from the substrate surface as a result of partially retarded hardening of the concrete-based material and removal of thus produced, unhardened concrete-based material.

Also, according to this disclosure, in producing the concrete product having a retroreflective surface, a substrate having a concrete-based material and a retroreflective element dispersed and embedded at least in a surface portion of said substrate, at least a part of which element is exposed from a surface of said substrate. A production process is also provided and is characterized by

(1) applying and pasting cement hardening-controlling sheet to a predetermined site of the production mold,

(2) pouring a retroreflective element and a raw concrete material, in sequence, or a raw concrete material containing a retroreflective element in said production mold; separating the produced concrete-based material from the production mold after hardening of the raw concrete material; and

(3) removing the raw concrete material portion which is unhardened due to contact with said cement hardening-controlling sheet from said concrete-based material, thereby partially exposing the retroreflective element from said concrete-based material.

This disclosure also provides a production process of the concrete product characterized by that hardening-controlling material is coated on the mold and dried without using a cement hardening-controlling sheet, raw material concrete is poured in the same process with said production process and hardened.

### BRIEF DESCRIPTION OF THE DRAWINGS

FIG. 1 is a schematic cross section of a preferred application example of the concrete product prepared according to this invention.

FIG. 2 is a schematic cross section of an example of cement hardening-controlling sheet which is effectively used in the application of this invention.

FIGS. 3a-c are a series of schematic cross sections of the production process of the concrete product of FIG. 1.

FIG. 4 is a schematic cross section of another production process (partial) of the concrete product of this invention.

### DESCRIPTION

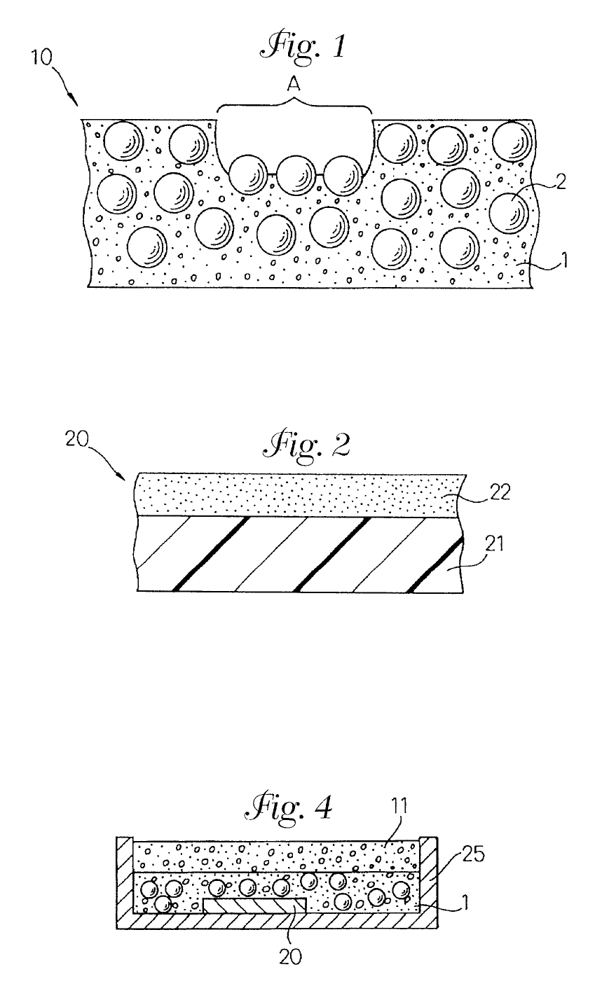

FIG. 1 is a schematic cross sectional view of a preferred embodiment of concrete product produced according to this invention. Concrete product 10 has a substrate 1 comprising a concrete-based material and retroreflective element 2 dispersed and embedded in the whole area of the substrate. In the concrete product 10 in the figure, surface area of retroreflective element 2 is exposed from the substrate 1 in the limited surface area of A, therefore, a retroreflective surface is supplied.

Concrete product 10 of FIG. 1 is a typical constituent example and it is needless to say that other different constitution can be adopted as far as the constitution is within the scope of this invention. Some preferred embodiments of constitution are listed as follows.

(1) Concrete-based material which constitutes substrate 1 may optionally contain additives such as coloring agent and filler.

(2) In substrate 1, retroreflective element 2 may be dispersed and embedded throughout the thickness, may be dispersed and embedded only in the surface area (surface layer) or may be dispersed and embedded by limiting in the vicinity of retroreflective surface

(3) Condition of exposure of retroreflective element 2 may be changed widely depending on the factors such as desired effect and location where concrete product is used. This means that only the surface area A can be exposed as shown in the figure and obtain patterned retroreflectivity, otherwise the element can be exposed uniformly on the whole surface of concrete product 10 to obtain other effect.

(4) Substrate 1 may be used solely, otherwise it may be combined and used with other supportive material.

(5) Concrete product 10 may have additional layers such as a coloring layer, a surface protection layer and a waterproof layer in any desired position.

In the application of this invention, the concrete-based material which constitutes the substrate of the concrete product is not particularly limited as far as the inside of the material is dispersed and embedded with retroreflective element and the expected effect is obtained. As for the appropriate concrete-based material, cement, cement mixture which was obtained by mixing cement, aggregate and concrete miscible agent, mortar, concrete paste and mortar for decorative use are listed. In the application of this invention, the kind of cement, aggregate and concrete miscible agent is not limited. However, other than the kind of cement, mixing rate of the cement and water and the kind and adding volume of concrete miscible agent, the performance of cement hardening-controlling sheet that means the depth to wash out cement in the final process by preventing the hardening of cement (consequently, the depth to expose retroreflective element represented by glass beads) is affected by the hardening (curing) condition of the concrete. Therefore, in order to obtain optimum washing depth, it is preferable to optimize this condition. Here, the optimum depth of washing is shown by the exposure rate of the retroreflective element and it is the depth when more than 50% of the total volume of these elements is exposed. These concrete-based materials may be colored if necessary and may contain optional additive.

The retroreflective element embedded in concrete-based material is not particularly limited as far as the desired retroreflectivity is obtained, however, from the stand point of easy purchasing and excellent retroreflectivity and strength, the use of fine spheres of transparent glass or plastic is very advantageous. However, depending on the need, the element of prism form that means reflective body of cube corner or other form of reflective body can be used in place of these fine spheres.

The fine spheres of transparent glass or plastic are conventionally used retroreflective element. These fine spheres can generally give retroreflective luminance of satisfactory level to the wide range incidence angle. The fine spheres are preferably in spherical shape in order to give uniform and ample retroreflectivity. Furthermore, these fine spheres are preferably and virtually transparent to optimize the amount of light absorbed by the fine spheres. Also, the fine spheres are generally and virtually colorless, however, if desired, they could be colored optionally in desired colors to cause special effect.

The fine spheres can be fabricated from any type of glass or plastic as far as desired optical property and physical property are obtained. As for an appropriate fine sphere material, although it is not limited to those listed below, resin material which has high transparency such as polymethacrylate ester resin and acrylic resin are listed as examples. Also, if necessary, these fine spheres may be applied with cover film such as a coloring film and metal vapor deposit film on the surface of the sphere.

The size of the fine spheres (mean particle diameter) can be changed depending on the various factors such as the constitution of fine sphere and where concrete product is used and not limited particularly, however, it is preferable to be within the sizes between 0.5 mm and 3 mm. When the particle diameter of the fine sphere is smaller than 0.5 mm, good retroreflectivity is difficult to be achieved, on the other hand, if it exceeds 3 mm, the space between the adjacent fine spheres becomes too large and it is not preferred in design aspect. Naturally, as this range of the sphere diameter is for general use, in some case, smaller or larger fine spheres can be used. Also, in order to obtain higher retroreflectivity, preferred reflective index of fine sphere is 1.8 or higher.

In the example described above, the retroreflective element is exposed from the surface of the substrate and presents desired retroreflective performance and the exposure of such retroreflective element results from the production process of the concrete product. In other words, in the concrete product, exposure of retroreflective elements is realized by the partially retarded hardening of the concrete-based material and removal of the unhardened concrete-based material which is caused partially by the controlled hardening, not by the traditional method for the concrete product in which the exposure is caused from vibrating the concrete poured into the mold under the pressure, pouring the concrete after retroreflective element is fixed in advance to the mold and washing the surface of hardened concrete with acid. Also, partially retarded hardening of concrete-based material is done by pasting the cement hardening-controlling sheet in the predetermined site of the production mold.

The level of exposure of the retroreflective element in the concrete product of this invention can be changed according to the desired retroreflective functionality and other purposes, however, normally, considering one retroreflective element, it is preferred that about 20% to 60% or more of the element which exists in the upper part is exposed. If the level of exposure is too low, enough retroreflectivity can not be obtained, conversely, if too much portion of the element is exposed, each element can not be embedded in the substrate in stable condition for a long time. The more preferable level of exposure is 40% to 55% or higher and the most preferred level is higher than 50%.

The cement hardening-controlling sheet which can be used effectively in the application of this invention can include various type of sheets. For example, cement hardening-controlling sheet can be one or more than two pieces of sheet material which has cement hardening delaying capability on its own. Also, such kind of sheet can be layered to proper supportive sheet for reinforcement in case the sheet is too thin or lacking strength. Also, such sheets can be coated with adhesive or tacky agent on one side of the sheet (mold side surface) or applied with double-sided adhesive tape to enforce bonding of the sheet to the production mold. Furthermore, if it is effective for such as temporary fixing retroreflective element, the other surface (top surface of raw material concrete side) may be applied with similar adhesive treatment. In addition to this, to improve handling of the sheet, such as release liner may be applied on the surface treated with adhesive.

Cement hardening-controlling sheet can be used effectively in the form of sheet type substrate having a resinous layer. The resinous layer may have cement hardening delaying capability as its own property, otherwise may have latent cement hardening delaying capability. This cement hardening-controlling sheet is constructed preferably with a substrate made of plastic material and a resinous layer containing at least one kind of hydrophilic poly (ester) acrylate having adhesive property which is layered at least on one side of the substrate and hydrophilic plasticizer which does not have cement hardening delaying property as its own property. Such cement hardening-controlling sheet has a resinous layer which has cement hardening delaying property on one side of the substrate and preferably the sheet is coated with adhesive or tacky agent or is applied with double sided bonding tape on the other surface (mold side surface) for stronger fixation. In this cement hardening-controlling sheet, it is preferred to protect the surface treated with adhesive (if any) by covering with such as a release liner.

A preferred application example of the cement hardening-controlling sheet having a resinous layer as described above is schematically shown in FIG. 2. Cement hardening-controlling sheet 20 is constituted of a substrate 21 made of plastic material and a resinous layer 22 which is layered on one side of the substrate and containing at least one kind of hydrophilic poly (ester) acrylate having adhesive property and hydrophilic plasticizer which does not have cement hardening delaying property as its own property. Although, it is not shown in the figure, the resinous layer may be layered on both sides of the substrate if necessary and additional layer may be added voluntarily to improve performance.

The support substrate is made of plastic material and preferably, it is used in the form of film. This plastic film used as a substrate is the one which preferably does not elongate of shrink before and after the vapor curing process of concrete and have dimensional stability. Suitable plastic films are such as polyester film and polyolefin film. It is preferable to use a substrate coated with polyethylene on the both side of the textile woven with the flat yam made of synthetic fiber. PET film is preferably used as well. The thickness of the substrate can be changed widely depending on the purpose of using cement hardening-controlling sheet and normally, the preferred range of thickness is between 10 and 500 μm.

The resinous layer supported by a substrate has preferably,

(1) at least one kind of hydrophilic poly (ester) acrylate having adhesive property and

(2) hydrophilic plasticizer which does not have cement hardening delaying capability as its own property.

Poly (ester) acrylate contains ester acrylate or polymer of methacrylate and the described “polymer” here contains copolymers such as two component copolymer, three component copolymer in addition to homo-polymer as generally recognized in polymer chemistry.

Poly (ester) acrylate is poly (ester) acrylate which is made by homopolymerization and copolymerization of acrylic monomer represented by the following formula (I).

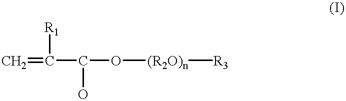

In the above described formula, R₁ represents hydrogen or methyl group, R₂ represents alkylene group having 2 to 4 carbon atoms, ethylene group and propylene group for example, R₃ represents alkyl group which has hydrogen and 2 to 4 carbon atoms for example, ethylene group and propylene group or substituted or non substituted phenyl group for example and n is integer between 1 and 25.

Acrylic monomer represented by the formula (I) shown above is not limited concretely to those listed below, however it contains such as methoxyethyl (metha) acrylate, ethoxyethyl (metha)acrylate, polyethylene glycol mono (metha) acrylate, polypropylene glycol mono (metha) acrylate, polybutylene glycol mono (metha) acrylate, methoxy polyethylene glycol mono (metha) acrylate, methoxy polypropylene glycol mono (metha) acrylate, methoxy polybutylene glycol mono (metha) acrylate, ethoxy polyethylene glycol mono (metha) acrylate, ethoxy polypropylene glycol mono (metha) acrylate, ethoxy polybutylene glycol mono (metha) acrylate, nonyl phenoxy polyethylene glycol mono (metha) acrylate. These monomers can be used solely or used in combination with more than two kinds of monomers. Also, such acrylic monomer may be copolymerized with other acrylic monomer which is capable of copolymerization with the monomer.

Acrylic monomers which can be used for copolymerization are not particularly limited as far as being capable of copolymerizing with the acrylic monomer in formula (I), however, it is preferable to mix components which give cohesion at an appropriate rate. These are 2-ethyl hexyl acrylate, n-butyl acrylate, isooctyl acrylate, isononyl acrylate, lauryl methacrylate which give tacky property and (metha) acrylate, crotonic acid, itaconic acid, fumaric acid, maleic acid, acrylamide, acrylonitrile, vinyl acetate, N-vinyl pyrrolidone, N-vinyl caprolactam, acryloyl morphorine, N,N-dimethyl acrylamide, 2-hydroxy ethyl (metha) acrylate, styrene. Also, thus obtained poly (ester) acrylate can adjust tacky property by adding plasticizer and tackifier.

It is preferable that poly (ester) acrylate explained above, including the ones having the form of copolymer has an average molecular weight of between 100,000 and 500,000.

The cement hardening-controlling sheet of this invention can be made by coating above mentioned resinous solution and forming a resinous layer on at least one side of the above mentioned substrate, for example. The resinous layer is usually formed on one side of the substrate, however, if layers are needed on both side of the substrate, another layer of resin can be utilized for the adhesion of sheet to such as mold. As for the coating method, traditional coating methods such as knife coating and reverse roll coating are used. After the coating of the resin solution, the coated film is dried. As for the method of drying, there is a method to remove water and solvent by the heat in the oven.

The resinous layer of cement hardening-controlling sheet used in this invention has preferably a thickness of 5 to 300 μm.

Additional layer may be incorporated to the cement hardening-controlling sheet as necessary. Adhesion-enhancing agent layer to increase adhesion between the substrate and resinous layer, mold release treating layer which is layered on the other side of resinous layer of the substrate are listed as appropriate additional layer.

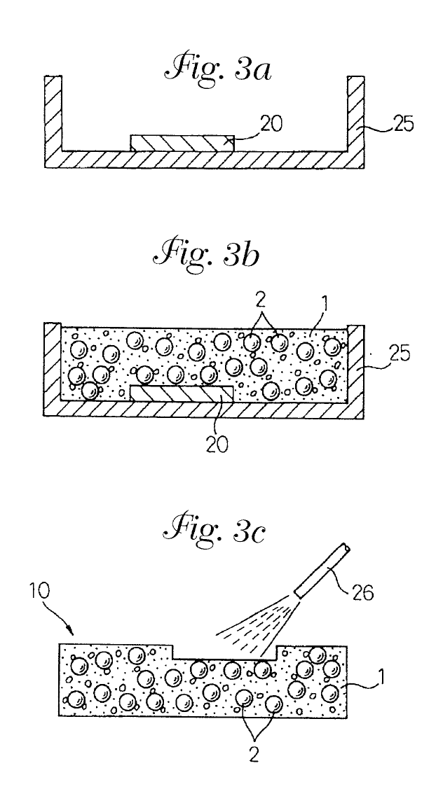

Concrete product 10 explained by referring to FIG. 1 can be produced effectively by following the process explained in order in FIGS. 3a-c. As shown in FIG. 3a, a cement hardening-controlling sheet 20 is placed so that its resinous layer side is facing upward in the predetermined site (a position to which retroreflective property is expected to appear on the top surface of the concrete plate) of a mold 25 which has a shape and dimension to fit the concrete product being produced (here, a concrete plate). Cement hardening-controlling sheet 20 used here is a type previously explained by referring to FIG. 2, the cement hardening-controlling sheet 20 which has cement hardening delaying capability as its own property may be applied by using such as a double sided adhesive tape. Also, the cement hardening-controlling sheet 20 is cut into a desired shape and size and used in this case, however, the cement hardening-controlling sheet 20 may be bonded to the entire bottom surface of the mold 25 in other case. Furthermore, although not shown in the figure, cement hardening-controlling sheet may be substituted with cement hardening-controlling material (for example, a similar composition with the above-mentioned resinous layer) may be coated on the bottom surface of the mold and dried.

Next, as shown in FIG. 3b, raw material concrete which forms the substrate, for example a concrete paste (shown as reference number 1, same with the substrate, herein for the sake of convenience) obtained by mixing such as cement, glass beads, water and other mixing agent for concrete, is poured into the mold 25. In the example of the figure, one kind of raw material concrete is poured into the mold 25, however, as shown in FIG. 4, two different kind of raw concrete 1 and 11 may be poured in order. In case of FIG. 4, raw material concrete 1 is decorative concrete and raw material concrete 11 is structural concrete. Raw material concrete may be colored to the desired color depending on the need.

Then, raw material concrete in the mold 25 is hardened by such as vapor curing. The hardening of the raw material concrete 1 in the mold 25 progresses evenly, however, in the area where the sheet 20 contacts adhesive layer, the hardening is interrupted because of the cement hardening delaying capability of the adhesive layer.

After the hardening of the raw material concrete is completed, concrete plate is removed from the mold and the part of the concrete which was contacting the cement hardening-controlling sheet is washed by high-pressure water or by rubbing with a brush, for example. By rubbing with a brush while the object is dry, uncured concrete which contacts the cement hardening-controlling sheet is removed easily, for example. As necessary, remaining concrete pieces may be removed by rinsing with water. In FIG. 3c, a process to rinse off top surface area of concrete plate 10 by using high-pressure water from the hose 26 is shown. By this process, unhardened concrete on the surface of the concrete plate 10 is washed off Consequently, as shown in FIG. 1, the concrete plate 10 having a retroreflective surface resulting from the glass beads 2 is obtained.

By using the process, a part of the cement which is contacting the cement hardening-controlling sheet does not harden while other part hardens during the curing process and it is removed or rinsed off easily by applying a cement hardening-controlling sheet which is cut into the desired size and shape in a site of the mold where the retroreflectivity is needed. Therefore, concrete products with excellent design possibility and retroreflective surface are obtained easily and regularly. Also, the concrete product produced according to this invention is effectively applied in a vast field by using its characteristics. Some examples of its appropriate usage include interlocking block used on a cross walk or shopping malls and amusement parks, guiding blocks used in such as a parking lots, zebra pattern on the road (cross section), traffic signs, protective wall of the road bank and gate pillars.

### EXAMPLES

This invention is explained by referring to the application example. “Parts” described in the application example described below means “weight parts” unless specified differently.

### Example 1

Production of cement hardening-controlling sheet

In a reactor equipped with a reflux condenser, thermometer and nitrogen gas blowing hole, 700 parts ethyl acetate, 75 parts iso octyl acrylate, 75 parts n-butyl acrylate, 120 parts methoxy polyethylene glycol (n=9) monoacrylate (brand name “NK Ester™ AM-90G), 15 parts 2-hydroxy ethyl acrylate and 15 parts acrylamide are poured. After 1.5 parts AIBN (azo bis-2,4-dimethyl valero nitrile as polymerization initiating agent) is incorporated, solution polymerization was performed in the atmosphere of nitrogen gas, at the temperature of 50° C. for 20 hours. After the completion of polymerization, reacted product is cooled down to the room temperature and 30 parts surfactant, Emulgen™ 950 (made by Kao) is added, The resin solution of the objective is obtained.

Next, a film coated with polyethylene on the both surfaces of the textile woven with flat yarns made by synthetic fiber (brand name “PE Lami-Cloth”, made by Ogihara Industry) is prepared and one side of the film is coated with the resin solution prepared by the previous process by a knife coater so that the thickness of the dried resin layer becomes 30 μm and the film sheet is dried. The cement hardening-controlling sheet of the objective is obtained.

### Application Example 2

In this example, a concrete product (concrete plate having a retroreflective surface) is produced by using a similar method described in order in FIGS. 3a-c.

The cement hardening-controlling sheet which is fabricated according to above-described application example is cut into a predetermined shape, then, as shown in FIG. 3a, the cut sheet is bonded with double sided tape on the bottom wall of mold 25 so that the resinous layer side of cement sheet 20 would face upward. The raw concrete material used here is a decorative concrete paste obtained by mixing 100 parts white color cement (made by Taiheiyo Cement) and 300 parts glass beads (brand name “BZ-04”, made by Inouchi Seiei Do) and adding 50 parts water and mixing completely. The raw concrete material in the mold 25 is left in the room temperature for 24 hours and hardened.

After the completion of the hardening of the raw concrete material, the obtained concrete plate is removed from the mold and the area contacting the cement hardening-controlling sheet of the concrete plate surface is rubbed by a brush and rinsed with water and unhardened concrete is washed off. Concrete plate having a partially retroreflective surface which results from glass beads is obtained.

### Application Example 3

The process described in above-mentioned Application Example 2 is repeated, however, in this example, the cement hardening-controlling sheet fabricated in Application Example 1 is replaced with commercially sold cement hardening preventing tacky tape (brand name “Scotch # 9398), made by Sumitomo 3M) and used. A concrete plate which is similar to the one fabricated according to above described application example 2, having a partially retroreflective surface resulting from glass beads is obtained.

### Application Example 4

The process described in Example 3 is repeated, however, in this example, as shown in FIG. 4, decorative concrete and structural concrete are combined and used as the raw concrete material. This means, the decorative concrete paste is poured into the mold by the same method with the above-described Application Example 2. After being left in room temperature for 24 hours, structural concrete is poured on the hardened decorative concrete layer. The structural concrete used here is made by adding and mixing 100 parts commercially sold concrete (brand name “Jaricon” made by Kagoshima Concrete) and 13 parts water. Furthermore the poured concrete is left for 24 hours in a room temperature.

After the completion of hardening of the structural concrete, the obtained concrete plate is removed from the mold and the area contacting the cement hardening-controlling sheet of the concrete plate surface is rubbed by a brush and rinsed with water and unhardened concrete is washed off. Structural concrete plate having a retroreflective surface resulting from glass beads in a decorative concrete layer is obtained.

### Application Example 5

The process described in above-mentioned Application Example 3 is repeated, however, in this example, commercially sold cement hardening preventive tacky tape (brand name “Scotch 9398”) used in Application Example 3 is substituted with commercially sold cement hardening preventive tape (brand name “Scotch 4819”, made by Sumitomo 3M) and used. This tape #4819 is bonded to silicone liner and furthermore a double-sided tape is bonded on the back surface of the tape. Thus obtained, layered tape is cut into a predetermined shape and the liner is peeled off so that the tacky surface of the tape #4819 is exposed and glass beads of which particle diameter are about 5 mm (made by Inouchi Seiei Do) are spread to the entire bottom wall of the mold. Glass beads are stuck and fixed to the only surface where tacky agent is exposed. After removing the unfixed glass beads from the mold, white paint which cures in a room temperature is coated by brush on the back side of the glass beads. The painted surface is left for 24 hours, dried and hardened. Then, structural concrete is poured into the mold including the area of the glass beads painted by the white paint. The structural concrete used here is the same one used in the above-described Application Example 4. The structural concrete was left in a room temperature for 24 hours and hardened.

After the completion of hardening of the concrete, the obtained concrete plate is removed from the mold and the area contacting the cement hardening-controlling sheet of the concrete plate surface is rubbed by a brush and rinsed with water and unhardened concrete is washed off. Concrete plate having a partially retroreflective surface resulting from glass beads is obtained.

As explained above, according to this invention, concrete product having a retroreflective, uniform surface with sharp edge can be provided. Also, such concrete product can be produced easily and with shortened time, without using a special equipment, process and chemicals which need special attention in handling as well.

1. A concrete product having a retroreflective surface, the concrete product comprising a substrate having a concrete-based material and a retroreflective element dispersed and embedded at least in a surface portion of said substrate, at least a part of the retroreflective element is exposed from a surface of said substrate and said retroreflective element being exposed from the substrate surface as a result of partially retarded hardening of the said concrete-based material and removal of the unhardened concrete material.

2. The concrete product described in claim 1, wherein said retroreflective element is composed of fine spheres of transparent glass or plastic material.

3. A process for the production of concrete products having a retroreflective surface which comprises a substrate having a concrete-based material and a retroreflective element dispersed and embedded at least in a surface portion of said substrate, at least a part of which element is exposed from a surface of said substrate, comprising:
applying a cement hardening-controlling sheet to a predetermined site of the product mold;
pouring a retroreflective element and a raw concrete material in said production mold;
separating the produced concrete-based material from the production mold after hardening of the raw concrete material; and
removing the raw concrete material portion which is unhardened due to contact with said cement hardening-controlling sheet from said concrete-based material, and partially exposing the retroreflective element from said concrete-based material.

4. The production process described in claim 3, wherein said retroreflective element is composed of fine spheres of transparent glass or plastic material.

5. The production process described in claim 4, wherein said cement hardening-controlling sheet has a resinous layer which has cement hardening-delaying capability as its own property or has a latent cement hardening-delaying capability.

6. The production process described in claim 5, wherein said cement hardening-controlling sheet comprising a substrate of the plastic material and a resinous layer laminated to at least one surface of said substrate, said resinous layer comprising at least one hydrophilic acrylic ester polymer having an adhesion property and a hydrophilic plasticizer having no cement hardening-controlling capability as its own property.

7. The production process according to claim 6, wherein said acrylic ester polymer is a polymer of acrylic ester produced upon homopolymerization or copolymerization of the acrylic monomer represented by the following formula (I): 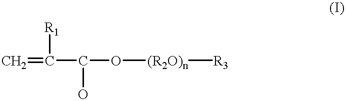
in which
R₁ represents hydrogen or a methyl group;
R₂ represents an alkylene group of 2 to 4 carbon atoms;
R₃ represents hydrogen, an alkyl group of 2 to 4 carbon atoms or a substituted or unsubstituted phenyl group, and
n is an integer of 1 to 25, and
has an average molecular weight of 100,000 to 5,000,000.
